(19) United States
(12) Patent Application Publication
(10) Pub. No.: US 2003/0084321 A1
(43) Pub. Date: May 1, 2003

(54) Node and mobile device for a mobile telecommunications network providing intrusion detection

(76) Inventors: Richard Paul Tarquini, Apex, NC (US); Richard Louis Schertz, Raleigh, NC (US); George Simon Gales, Plano, TX (US)

Correspondence Address: HEWLETT-PACKARD COMPANY, Intellectual Property Administration, P.O. Box 272400, Fort Collins, CO, 80527-2400, US

(21) Appl. No.: 10/001,728

(22) Filed: Oct. 31, 2001

(51) Int. Cl. G06F 11/30

(52) U.S. Cl. 713/200; 713/153

(57) ABSTRACT

A mobile device operable in a mobile telecommunications network comprising a memory module for storing data in machine readable format for retrieval and execution by a central processing unit and an operating system operable to execute an intrusion detection application stored in the memory module is provided. A node of a network for managing an intrusion detection system comprising a memory module for storing data in machine readable format for retrieval and execution by a central processing unit and an operating system comprising a network stack comprising a protocol driver and a media access control driver and operable to execute an intrusion protection system management application, the management application operable to receive text-file input defining a network-exploit rule and convert the text-file input into a signature file comprising machine-readable logic representative of an exploit-signature, the node operable to transmit the signature file to a mobile device over a radio frequency link is provided.

### CROSS-REFERENCE TO RELATED APPLICATIONS

This patent application is related to co-pending U.S. patent application, Ser. No. ______, entitled “METHOD AND COMPUTER READABLE MEDIUM FOR SUPPRESSING EXECUTION OF SIGNATURE FILE DIRECTIVES DURING A NETWORK EXPLOIT,” filed Oct. 31, 2001, co-assigned herewith; U.S. patent application, Ser. No. ______, entitled “SYSTEM AND METHOD OF DEFINING THE SECURITY CONDITION OF A COMPUTER SYSTEM,” filed Oct. 31, 2001, co-assigned herewith; U.S. patent application, Ser. No. ______, entitled “SYSTEM AND METHOD OF DEFINING THE SECURITY VULNERABILITIES OF A COMPUTER SYSTEM,” filed Oct. 31, 2001, co-assigned herewith; U.S. patent application, Ser. No. ______, entitled “SYSTEM AND METHOD OF DEFINING UNAUTHORIZED INTRUSIONS ON A COMPUTER SYSTEM,” filed Oct. 31, 2001, co-assigned herewith; U.S. patent application, Ser. No. ______, entitled “NETWORK INTRUSION DETECTION SYSTEM AND METHOD,” filed Oct. 31, 2001, co-assigned herewith; U.S. patent application, Ser. No. ______, entitled “NODE, METHOD AND COMPUTER READABLE MEDIUM FOR INSERTING AN INTRUSION PREVENTION SYSTEM INTO A NETWORK STACK,” filed Oct. 31, 2001, co-assigned herewith; U.S. patent application, Ser. No. ______, entitled “METHOD, COMPUTER-READABLE MEDIUM, AND NODE FOR DETECTING EXPLOITS BASED ON AN INBOUND SIGNATURE OF THE EXPLOIT AND AN OUTBOUND SIGNATURE IN RESPONSE THERETO,” filed Oct. 31, 2001, co-assigned herewith; U.S. patent application, Ser. No. ______, entitled “NETWORK, METHOD AND COMPUTER READABLE MEDIUM FOR DISTRIBUTED SECURITY UPDATES TO SELECT NODES ON A NETWORK,” filed Oct. 31, 2001, co-assigned herewith; U.S. patent application, Ser. No. ______, entitled “METHOD, COMPUTER READABLE MEDIUM, AND NODE FOR A THREE-LAYERED INTRUSION PREVENTION SYSTEM FOR DETECTING NETWORK EXPLOITS,” filed Oct. 31, 2001, co-assigned herewith; U.S. patent application, Ser. No. ______, entitled “SYSTEM AND METHOD OF AN OS-INTEGRATED INTRUSION DETECTION AND ANTI-VIRUS SYSTEM,” filed Oct. 31, 2001, co-assigned herewith; U.S. patent application, Ser. No. ______, entitled “METHOD, NODE AND COMPUTER READABLE MEDIUM FOR IDENTIFYING DATA IN A NETWORK EXPLOIT,” filed Oct. 31, 2001, co-assigned herewith; U.S. patent application, Ser. No. ______, entitled “NODE, METHOD AND COMPUTER READABLE MEDIUM FOR OPTIMIZING PERFORMANCE OF SIGNATURE RULE MATCHING IN A NETWORK,” filed Oct. 31, 2001, co-assigned herewith; U.S. patent application, Ser. No. ______, entitled “METHOD, NODE AND COMPUTER READABLE MEDIUM FOR PERFORMING MULTIPLE SIGNATURE MATCHING IN AN INTRUSION PREVENTION SYSTEM,” filed Oct. 31, 2001, co-assigned herewith; U.S. patent application, Ser. No. ______, entitled “USER INTERFACE FOR PRESENTING DATA FOR AN INTRUSION PROTECTION SYSTEM,” filed Oct. 31, 2001, co-assigned herewith; U.S. patent application, Ser. No. ______, entitled “METHOD AND COMPUTER-READABLE MEDIUM FOR INTEGRATING A DECODE ENGINE WITH AN INTRUSION DETECTION SYSTEM,” filed Oct. 31, 2001, co-assigned herewith; U.S. patent application, Ser. No. ______, entitled “SYSTEM AND METHOD OF GRAPHICALLY DISPLAYING DATA FOR AN INTRUSION PROTECTION SYSTEM,” filed Oct. 31, 2001, co-assigned herewith; and U.S. patent application, Ser. No. ______, entitled “SYSTEM AND METHOD OF GRAPHICALLY CORRELATING DATA FOR AN INTRUSION PROTECTION SYSTEM,” filed Oct. 31, 2001, co-assigned herewith.

### TECHNICAL FIELD OF THE INVENTION

This invention relates to network technologies and, more particularly, to a node and a mobile device for a mobile telecommunications network providing intrusion detection.

### BACKGROUND OF THE INVENTION

Network-exploit attack tools, such as denial-of-service (DoS) attack utilities, are becoming increasing sophisticated and, due to evolving technologies, simple to execute. Relatively unsophisticated attackers can arrange, or be involved in, computer system compromises directed at one or more targeted facilities. A network system attack (also referred to herein as an intrusion) is an unauthorized or malicious use of a computer or computer network and may involve hundred or thousands of unprotected, or alternatively compromised, Internet nodes together in a coordinated attack on one or more selected targets.

Network attack tools based on the client/server model have become a preferred mechanism for executing network attacks on targeted networks or devices. High capacity machines in networks having deficient security are often desired by attackers to launch distributed attacks therefrom. University servers typically feature high connectivity and capacity but relatively mediocre security. Such networks also often have inexperienced or overworked network administrators making them even more vulnerable for involvement in network attacks.

Network-exploit attack tools, comprising hostile attack applications such as denial-of-service utilities, responsible for transmitting data across a network medium will often have a distinctive “signature,” or recognizable pattern within the transmitted data. The signature may comprise a recognizable sequence of particular packets and/or recognizable data that is contained within one or more packets. Signature analysis is often performed by a network intrusion prevention system (IPS) and may be implemented as a pattern-matching algorithm and may comprise other signature recognition capabilities as well as higher-level application monitoring utilities. A simple signature analysis algorithm may search for a particular string that has been identified as associated with a hostile application. Once the string is identified within a network data stream, the one or more packets carrying the string may be identified as “hostile,” or exploitative, and the IPS may then perform any one or more of a number of actions, such as logging the identification of the frame, performing a countermeasure, or performing another data archiving or protection measure.

Intrusion prevention systems (IPS) encompass technology that attempts to identify exploits against a computer system or network of computer systems. Numerous types of IPSs exist and each are generally classified as either a network-based, host-based, or node-based IPS.

Network-based IPS appliances are typically dedicated systems placed at strategic places on a network to examine data packets to determine if they coincide with known attack signatures. To compare packets with known attack signatures, network-based IPS appliances utilize a mechanism referred to as passive protocol analysis to inconspicuously monitor, or “sniff,” all traffic on a network and to detect low-level events that may be discerned from raw network traffic. Network exploits may be detected by identifying patterns or other observable characteristics of network frames. Network-based IPS appliances examine the contents of data packets by parsing network frames and packets and analyzing individual packets based on the protocols used on the network. A network-based IPS appliance inconspicuously monitors network traffic inconspicuously, i.e., other network nodes may be, and often are, unaware of the presence of the network-based IPS appliance. Passive monitoring is normally performed by a network-based IPS appliance by implementation of a “promiscuous mode” access of a network interface device. A network interface device operating in promiscuous mode copies packets directly from the network media, such as a coaxial cable, 100baseT or other transmission medium, regardless of the destination node to which the packet is addressed. Accordingly, there is no simple method for transmitting data across the network transmission medium without the network-based IPS appliance examining it and thus the network-based IPS appliance may capture and analyze all network traffic to which it is exposed. Upon identification of a suspicious packet, i.e., a packet that has attributes corresponding to a known attack signature monitored for occurrence by the network-based IPS appliance, an alert may be generated thereby and transmitted to a management module of the IPS so that a networking expert may implement security measures. Network-based IPS appliances have the additional advantage of operating in real-time and thus can detect an attack as it is occurring. Moreover, a network-based IPS appliance is ideal for implementation of a state-based IPS security measure that requires accumulation and storage of identified suspicious packets of attacks that may not be identified “atomically,” that is by a single network packet. For example, transmission control protocol (TCP) synchronization (SYN) flood attacks are not identifiable by a single TCP SYN packet but rather are generally identified by accumulating a count of TCP SYN packets that exceed a predefined threshold over a defined period of time. A network-based IPS appliance is therefore an ideal platform for implementing state-based signature detection because the network-based IPS appliance may collect all such TCP SYN packets that pass over the local network media and thus may properly archive and analyze the frequency of such events.

However, network-based IPS appliances may often generate a large number of “false positives,” i.e., incorrect diagnoses of an attack. False positive diagnoses by network-based IPS appliances result, in part, due to errors generated during passive analysis of all the network traffic captured by the IPS that may be encrypted and formatted in any number of network supported protocols. Content scanning by a network-based IPS is not possible on an encrypted link although signature analysis based on protocol headers may be performed regardless of whether the link is encrypted or not. Additionally, network-based IPS appliances are often ineffective in high speed networks. As high speed networks become more commonplace, software-based network-based IPS appliances that attempt to sniff all packets on a link will become less reliable. Most critically, network-based IPS appliances can not prevent attacks unless integrated with, and operated in conjunction with, a firewall protection system.

Host-based IPSs detect intrusions by monitoring application layer data. Host-based IPSs employ intelligent agents to continuously review computer audit logs for suspicious activity and compare each change in the logs to a library of attack signatures or user profiles. Host-based IPSs may also poll key system files and executable files for unexpected changes. Host-based IPSs are referred to as such because the IPS utilities reside on the system to which they are assigned to protect. Host-based IPSs typically employ application-level monitoring techniques that examine application logs maintained by various applications. For example, a host-based IPS may monitor a database engine that logs failed access attempts and/or modifications to system configurations. Alerts may be provided to a management node upon identification of events read from the database log that have been identified as suspicious. Host-based IPSs, in general, generate very few false-positives. However, host-based IPS such as log-watchers are generally limited to identifying intrusions that have already taken place and are also limited to events occurring on the single host. Because log-watchers rely on monitoring of application logs, any damage resulting from the logged attack will generally have taken place by the time the attack has been identified by the IPS. Some host-based IPSs may perform intrusion-preventative functions such as ‘hooking’ or ‘intercepting’ operating system application programming interfaces to facilitate execution of preventative operations by an IPS based on application layer activity that appears to be intrusion-related. Because an intrusion detected in this manner has already bypassed any lower level IPS, a host-based IPS represents a last layer of defense against network exploits. However, host-based systems are of little use for detecting low-level network events such as protocol events.

Node-based IPSs apply the intrusion detection and/or prevention technology on the system being protected. An example of node-based IPS technologies is inline intrusion detection. A node-based IPS may be implemented at each node of the network that is desired to be protected. Inline IPSs comprise intrusion detection technologies embedded in the protocol stack of the protected network node. Because the inline IPS is embedded within the protocol stack, both inbound and outbound data will pass through, and be subject to monitoring by, the inline IPS. An inline IPS overcomes many of the inherent weaknesses of network-based solutions. As mentioned hereinabove, network-based solutions are generally ineffective when monitoring high-speed networks due to the fact that network-based solutions attempt to monitor all network traffic on a given link. Inline intrusion prevention systems, however, only monitor traffic directed to the node on which the inline IPS is installed. Thus, attack packets can not physically bypass an inline IPS on a targeted machine because the packet must pass through the protocol stack of the targeted device. Any bypassing of an inline IPS by an attack packet must be done entirely by ‘logically’ bypassing the IPS, i.e., an attack packet that evades an inline IPS must do so in a manner that causes the inline IPS to fail to identify, or improperly identify, the attack packet. Additionally, inline IPSs provide the hosting node with low-level monitoring and detection capabilities similar to that of a network IPS and may provide protocol analysis and signature matching or other low-level monitoring or filtering of host traffic. The most significant advantage offered by inline IPS technologies is that attacks are detected as they occur. Whereas host-based IPSs determine attacks by monitoring system logs, inline intrusion detection involves monitoring network traffic and isolating those packets that are determined to be part of an attack against the hosting server and thus enabling the inline IPS to actually prevent the attack from succeeding. When a packet is determine to be part of an attack, the inline IPS layer may discard the packet thus preventing the packet from reaching the upper layer of the protocol stack where damage may be caused by the attack packet—an effect that essentially creates a local firewall for the server hosting the inline IPS and protecting it from threats coming either from an external network, such as the Internet, or from within the network. Furthermore, the inline IPS layer may be embedded within the protocol stack at a layer where packets have been unencrypted so that the inline IPS is effective operating on a network with encrypted links. Additionally, inline IPSs can monitor outgoing traffic because both inbound and outbound traffic respectively destined to and originating from a server hosting the inline IPS must pass through the protocol stack.

Although the advantages of inline IPS technologies are numerous, there are drawbacks to implementing such a system. Inline intrusion detection is generally processor intensive and may adversely effect the node's performance hosting the detection utility. Additionally, inline IPSs may generate numerous false positive attack diagnoses. Furthermore, inline IPSs cannot detect systematic probing of a network, such as performed by reconnaissance attack utilities, because only traffic at the local server hosting the inline IPS is monitored thereby.

Each of network-based, host-based and inline-based IPS technologies have respective advantages as described above. Ideally, an intrusion prevention system will incorporate all of the aforementioned intrusion detection strategies. Additionally, an IPS may comprise one or more event generation mechanisms that report identifiable events to one or more management facilities. An event may comprise an identifiable series of system or network conditions or it may comprise a single identified condition. An IPS may also comprise an analysis mechanism or module and may analyze events generated by the one or more event generation mechanisms. A storage module may be comprised within an IPS for storing data associated with intrusion-related events. A countermeasure mechanism may also be comprised within the IPS for executing an action intended to thwart, or negate, a detected exploit.

A particular arena that has been neglected in implementation of security systems therein is the mobile computing arena. Although cellular telecommunication systems are generally proprietary, proprietary architectures have been compromised and exploited in the past. Furthermore, several mobile device operating systems are publicly documented, such as Microsoft's Windows CE (TM) and Palm Computing's PalmOS (TM). Thus, it is a simple matter for trojan-horse type applications to be written for these platforms. Numerous existing applications have been ported to Microsoft's Windows CE that contain vulnerabilities.

Once a trojan-horse application has been installed on a mobile device, it is a simple matter to copy or corrupt the data on the device, use the mobile device to launch attacks against other systems, or use the device in other malicious forms. Given the increase in computer power of mobile computing devices and continuing expansion of commercially available wireless-device bandwidth, it is likely that network-based attacks targeting and/or comprising mobile devices will become more common.

### SUMMARY OF THE INVENTION

In accordance with an embodiment of the present invention, a mobile device operable in a mobile telecommunications network comprising a memory module for storing data in machine readable format for retrieval and execution by a central processing unit and an operating system operable to execute an intrusion detection application stored in the memory module is provided.

In accordance with another embodiment of the present invention, a node of a network for managing an intrusion detection system comprising a central processing unit, a memory module for storing data in machine readable format for retrieval and execution by the central processing unit, and an operating system comprising a network stack comprising a protocol driver and a media access control driver and operable to execute an intrusion protection system management application, the management application operable to receive text-file input defining a network-exploit rule and convert the text-file input into a signature file comprising machine-readable logic representative of an exploit-signature, the node operable to transmit the signature file to a mobile device over a radio frequency link is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an exemplary arrangement for executing a computer system compromise according to the prior art;

FIG. 2 illustrates a comprehensive intrusion prevention system employing network-based and hybrid host-based and node based intrusion detection technologies according to an embodiment of the invention;

FIG. 3 is an exemplary network protocol stack according to the prior art;

FIG. 4 illustrates a network node that may run an instance of an intrusion protection system application according to an embodiment of the present invention;

FIG. 5 illustrates an exemplary network node that may operate as a management node within a network protected by the intrusion protection system according to an embodiment of the present invention; and

FIG. 6 is a schematic of a mobile telecommunications system in which a mobile device according to an embodiment of the present invention may be serviced.

### DETAILED DESCRIPTION OF THE DRAWINGS

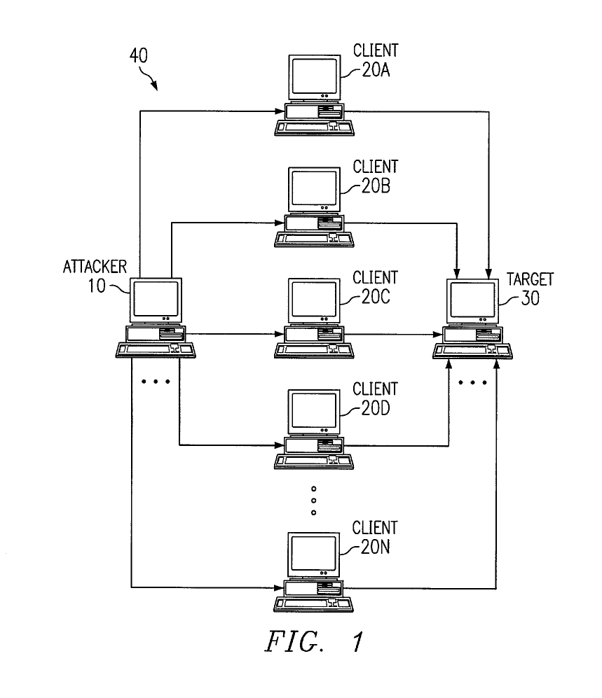

The preferred embodiment of the present invention and its advantages are best understood by referring to FIGS. 1 through 6 of the drawings, like numerals being used for like and corresponding parts of the various drawings.

In FIG. 1, there is illustrated an exemplary arrangement for executing a computer system compromise—the illustrated example showing a simplified distributed intrusion network 40 arrangement typical of distributed system attacks directed at a target machine 30. An attack machine 10 may direct execution of a distributed attack by any number of attack agents 20A-20N by one of numerous techniques such as remote control by IRC “robot” applications. Attack agents 20A-20N, also referred to as “zombies” and “attack agents,” are generally computers that are available for public use or that have been compromised such that a distributed attack may be launched upon command of an attack machine 10. Numerous types of distributed attacks may be launched against a target machine 30. The target machine 30 may suffer extensive damage from simultaneous attack by attack agents 20A-20N and the attack agents 20A-20N may be damaged from the client attack application as well. A distributed intrusion network may comprise an additional layer of machines involved in an attack intermediate the attack machine 10 and attack agents 20A-20N. These intermediate machines are commonly referred to as “handlers” and each handler may control one or more attack agents 20A-20N. The arrangement shown for executing a computer system compromise is illustrative only and may compromise numerous arrangements that are as simple as a single attack machine 10 attacking a target machine 30 by, for example, sending malicious probe packets or other data intended to compromise target machine 30. Target machine may be, and often is, connected to a larger network and access thereto by attack machine 10 may cause damage to a large collection of computer systems commonly located within the network.

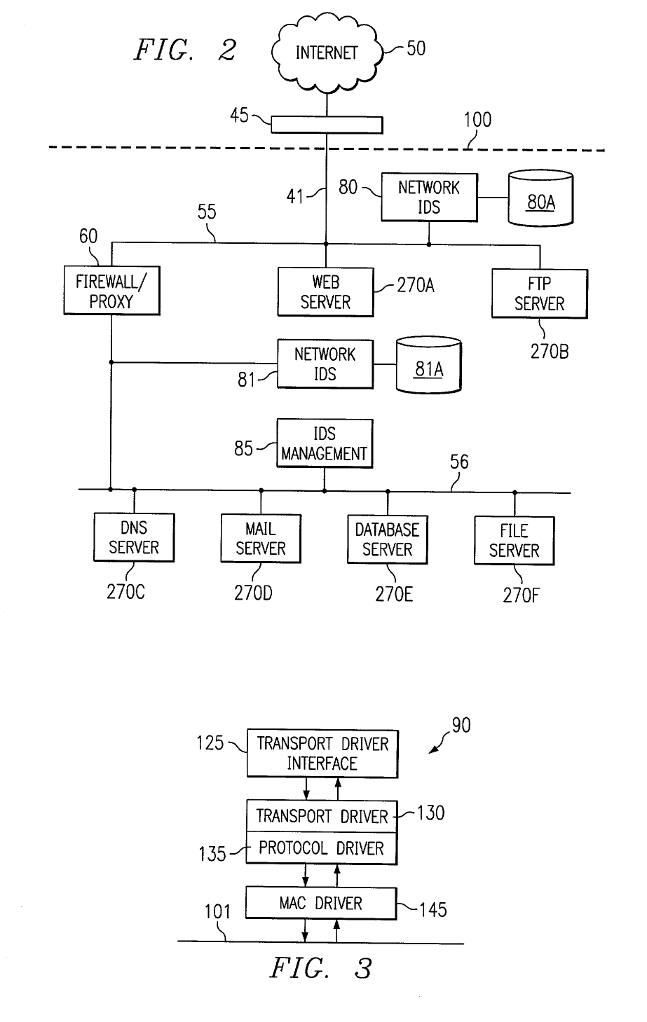

In FIG. 2, there is illustrated a comprehensive intrusion prevention system employing network-based and hybrid host-based/node-based intrusion detection technologies according to an embodiment of the invention. One or more networks 100 may interface with the Internet 50 via a router 45 or other device. In the illustrative example, two Ethernet networks 55 and 56 are comprised in network 100. Ethernet network 55 comprises a web-content server 270A and a file transport protocol-content server 270B. Ethernet network 56 comprises a domain name server 270C, a mail server 270D, a database sever 270E and a file server 270F. A firewall/proxy router 60 disposed intermediate Ethernets 55 and 56 provides security and address resolution to the various systems of network 56. A network-based IPS appliance 80 and 81 is respectively implemented on both sides of firewall/proxy router 60 to facilitate monitoring of attempted attacks against one or more elements of Ethernets 55 and 56 and to facilitate recording successful attacks that successfully penetrate firewall/proxy router 60. Network-based IPS appliances 80 and 81 may respectively comprise (or alternatively be connected to) a database 80A and 81A of known attack signatures, or rules, against which network frames captured thereby may be compared. Alternatively, a single database (not shown) may be centrally located within network 100 and may be accessed by network-based IPS appliances 80 and 81. Accordingly, network-based IPS appliance 80 may monitor all packets inbound from Internet 50 to network 100 arriving at Ethernet network 55. Similarly, a network-based IPS appliance 81 may monitor and compare all packets passed by firewall/proxy router 60 for delivery to Ethernet network 56. An IPS management node 85 may also be part of network 100 to facilitate configuration and management of the IPS components in network 100.

In view of the above-noted deficiencies of network-based intrusion prevention systems, a hybrid host-based and node-based intrusion prevention system is preferably implemented within each of the various nodes, such as servers 270A-270N (also referred to herein as “nodes”), of Ethernet networks 55 and 56 in the secured network 100. Management node 85 may receive alerts from respective nodes within network 100 upon detection of an intrusion event by any one of the network-based IPS appliances 80 and 81 as well as any of the nodes of network 100 having a hybrid agent-based and node-based IPS implemented thereon. Additionally, each node 270A-270F may respectively employ a local file system for archiving intrusion-related events, generating intrusion-related reports, and storing signature files against which local network frames and/or packets are examined.

Preferably, network-based IPS appliances 80 and 81 are dedicated entities for monitoring network traffic on associated Ethernets 55 and 56 of network 100. To facilitate intrusion detection in high speed networks, network-based IPS appliances 80 and 81 preferably comprise a large capture RAM for capturing packets as they arrive on respective Ethernet networks 55 and 56. Additionally, it is preferable that network-based IPS appliances 80 and 81 respectively comprise hardware-based filters for filtering network traffic, although IPS filtering by network-based IPS appliances 80 and 81 may be implemented in software. Moreover, network-based IPS appliances 80 and 81 may be configured, for example by demand of IPS management node 85, to monitor one or more specific devices rather than all devices on a common network. For example, network-based IPS appliance 80 may be directed to monitor only network data traffic addressed to web server 270A.

Hybrid host-based/node-based intrusion prevention system technologies may be implemented on all nodes 270A-270N on Ethernet networks 55 and 56 that may be targeted by a network attack. In general, each node is comprised of a reprogrammable computer having a central processing unit (CPU), a memory module operable to store machine-readable code that is retrievable and executable by the CPU, and may further comprise various peripheral devices, such as a display monitor, a keyboard, a mouse or another device, connected thereto. A storage media, such as a magnetic disc, an optical disc or another component operable to store data, may be connected to memory module and accessible thereby and may provide one or more databases for archiving local intrusion events and intrusion event reports. An operating system may be loaded into memory module, for example upon bootup of the respective node, and comprises an instance of a protocol stack as well as various low-level software modules required for tasks such as interfacing to peripheral hardware, scheduling of tasks, allocation of storage as well as other system tasks. Each node protected by the hybrid host-based and node-based IPS of the present invention accordingly has an IPS software application maintained within the node, such as in a magnetic hard disc, that is retrievable by the operating system and executable by the central processing unit. Additionally, each node executing an instance of the IPS application has a local database from which signature descriptions of documented attacks may be fetched from storage and compared with a packet or frame of data to detect a correspondence therebetween. Detection of a correspondence between a packet or frame at an IDS server may result in execution of any one or more of various security procedures.

The IPS described with reference to FIG. 2 may be implemented on any number of platforms. Each hybrid host-based/node-based instance of the IPS application described herein is preferably implemented on a network node, such as web server 270A operated under control of an operating system, such as Windows NT 4.0 that is stored in a main memory and running on a central processing unit, and attempts to detect attacks targeted at the hosting node. The particular network 100 illustrated in FIG. 2 is exemplary only and may comprise any number of network servers. Corporate, and other large scale, networks may typically comprise numerous individual systems providing similar services. For example, a corporate network may comprise hundreds of individual web servers, mail servers, FTP servers and other systems providing common data services.

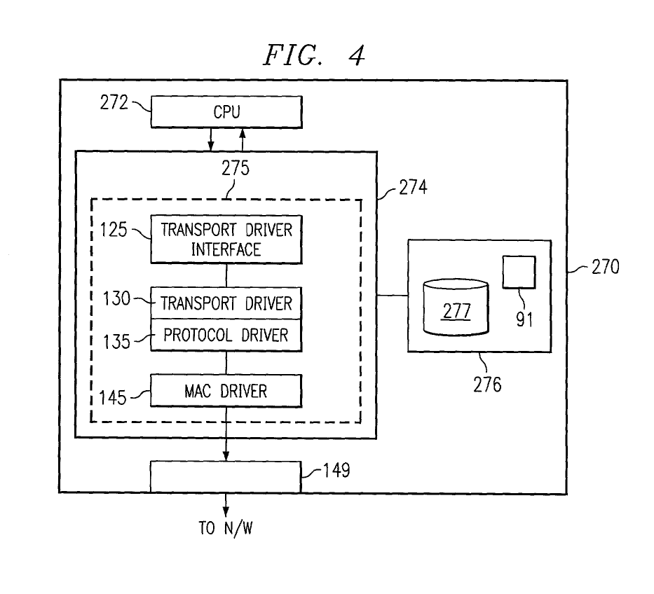

Each operating system of a node incorporating an instance of an IPS application additionally comprises a network protocol stack 90, as illustrated in FIG. 3, that defines the entry point for frames received by a targeted node from the network, e.g. the Internet or Intranet. Network stack 90 as illustrated is representative of the well-known WindowsNT (TM) system network protocol stack and is so chosen to facilitate discussion and understanding of the invention. However, it should be understood that the invention is not limited to a specific implementation of the illustrated network stack 90 but, rather, stack 90 is described to facilitate understanding of the invention. Network stack 90 comprises a transport driver interface (TDI) 125, a transport driver 130, a protocol driver 135 and a media access control (MAC) driver 145 that interfaces with the physical media 101. Transport driver interface 125 functions to interface the transport driver 130 with higher-level file system drivers. Accordingly, TDI 125 enables operating system drivers, such as network redirectors, to activate a session, or bind, with the appropriate protocol driver 135. Accordingly, a redirector can access the appropriate protocol, for example UDP, TCP, NetBEUI or other network or transport layer protocol, thereby making the redirector protocol-independent. The protocol driver 135 creates data packets that are sent from the computer hosting the network protocol stack 90 to another computer or device on the network or another network via the physical media 101. Typical protocols supported by an NT network protocol stack comprise NetBEUI, TCP/IP, NWLink, Data Link Control (DLC) and AppleTalk although other transport and/or network protocols may be comprised. MAC driver 145, for example an Ethernet driver, a token ring driver or other networking driver, provides appropriate formatting and interfacing with the physical media 101 such as a coaxial cable or another transmission medium.

The capabilities of the host-based IPS comprise application monitoring of: file system events; registry access; successful security events; failed security events and suspicious process monitoring. Network access applications, such as Microsoft IIS and SQL Server, may also have processes related thereto monitored.

Intrusions may be prevented on a particular IPS host by implementation of inline, node-based monitoring technologies according to an embodiment of the present invention. The inline-IPS is preferably comprised as part of a hybrid host-based/node-based IPS although it may be implemented independently of any host-based IPS system. The inline-IPS will analyze packets received at the hosting node and perform signature analysis thereof against a database of known signatures by network layer filtering.

In FIG. 4, there is illustrated a network node 270 that may run an instance of an IPS application 91 and thus operate as an IPS server. IPS application 91 may be implemented, as a three-layered IPS as described in co-pending application entitled “Method, Computer Readable Medium, and Node for a Three-Layered Intrusion Prevention System for Detecting Network Exploits” and filed concurrently herewith, and may comprise a server application and/or a client application. Network node 270, in general, comprises a central processing unit (CPU) 272 and a memory module 274 operable to store machine-readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 270, and comprises an instance of protocol stack 90 and may have an intrusion prevention system application 91 loaded from storage media 276. One or more network exploit rules, an exemplary form described in co-pending application entitled “Method, Node and Computer Readable Medium for Identifying Data in a Network Exploit” and filed concurrently herewith, may be compiled into a machine-readable signature(s) and stored within a database 277 that is loadable into memory module 274 and may be retrieved by a module of IPS application 91, for example an associative process engine of an inline intrusion detection module of IPS application 91, for facilitating analysis of network frames and/or packets. An exemplary arrangement of an inline intrusion detection application that may comprise an associative process engine and an input/output control layer that may be incorporated into IPS application 91 is described in copending application entitled “Method, Node and Computer Readable Medium for Inline Intrusion Detection on a Network Stack” and filed concurrently herewith.

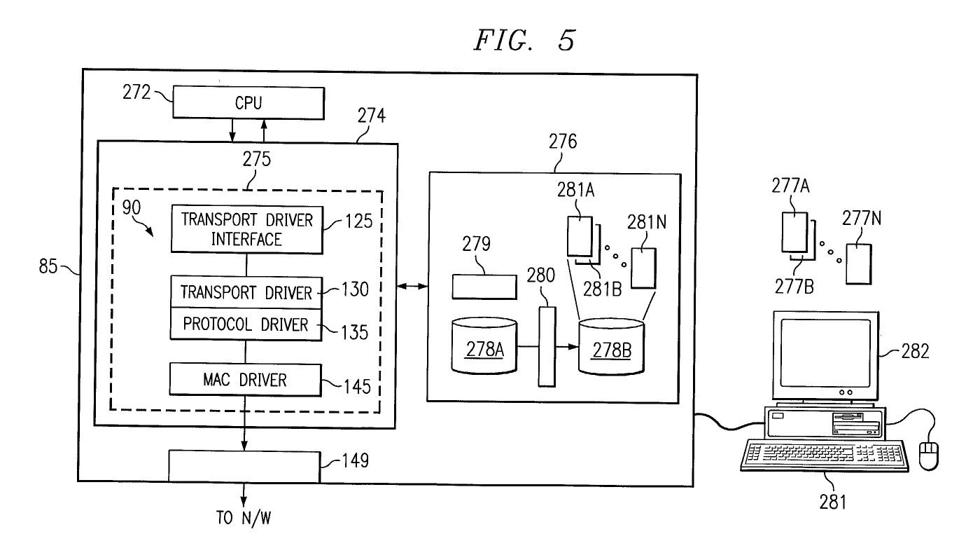

In FIG. 5, there is illustrated an exemplary network node that may operate as a management node 85 of the IPS of a network 100. Management node 85, in general, comprises a CPU 272 and a memory module 274 operable to store machine-readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 85, and comprises an instance of protocol stack 90. Operating system 275 is operable to fetch an IPS management application 279 from storage media 276 and load management application 279 into memory module 274 where it may be executed by CPU 272. Node 85 preferably has an input device 281, such as a keyboard, and an output device 282, such as a monitor, connected thereto.

An operator of management node 85 may input one or more text-files 277A-277N via input device 281. Each text-file 277A-277N may define a network-based exploit and comprise a logical description of an attack signature as well as IPS directives, such as instructions for IPS application 91 to log the identified packet and/or frame into a database, instructions to drop the identified packet and/or frame, and/or directions for other security measures to be executed upon an IPS evaluation of an intrusion-related event associated with the described attack signature. Each text file 277A-277N may be stored in a database 278A on storage media 276 and compiled by a compiler 280 into a respective machine-readable signature file 281A-281N that is stored in a database 278B. Each of the machine-readable signature files 281A-281N comprises binary logic representative of the attack signature as described in the respectively associated text-file 277A-277N and may comprise logic representative of one or more directives contained in the respective text file. An operator of management node 85 may periodically direct management node 85, through interaction with a client application of IPS application 279 via input device 281, to transmit one or more machine-readable signature files (also generally referred to herein as “signature files”) stored in database 278B to a node, or a plurality of nodes, in network 100. Alternatively, signature files 281A-281N may be stored on a computer-readable medium, such as a compact disk, magnetic floppy disk or another portable storage device, and installed on node 270 of network 100. Application 279 is preferably operable to transmit all such signature-files 281A-281N, or one or more subsets thereof, to a node, or a plurality of nodes, in network 100. Preferably, IPS application 279 provides a graphical user interface on output device 282 for facilitating input of commands thereto by an operator of node 85.

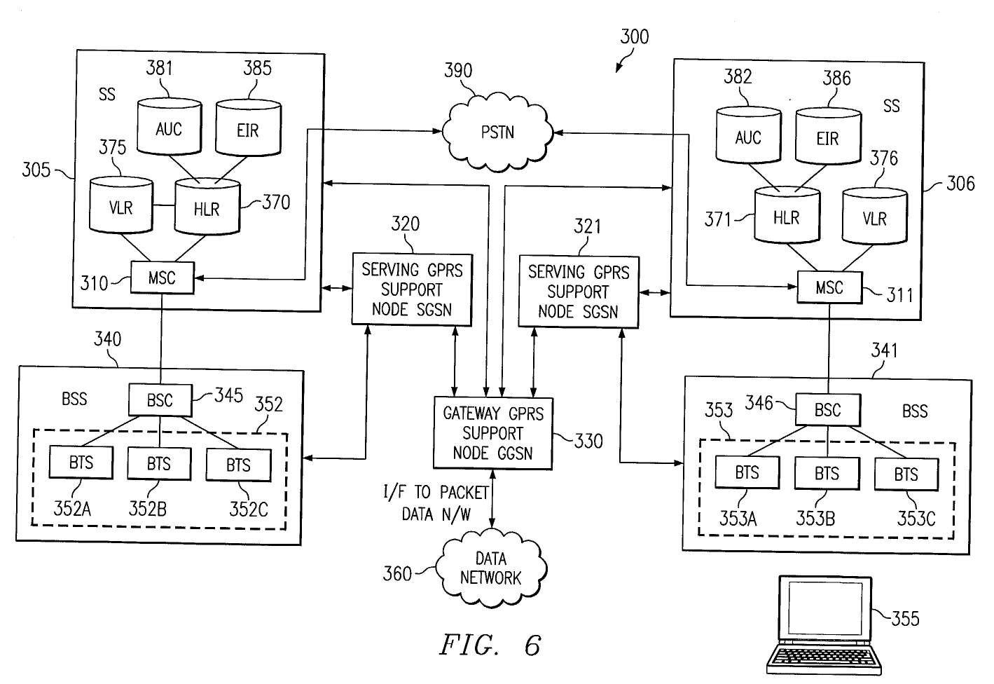

In FIG. 6, there is illustrated a mobile telecommunications system (MTS) 300 in which a mobile device of the present invention may be serviced. The exemplary mobile telecommunication system 300 is described according to the general infrastructure and nomenclature of the Global System for Mobile communications (GSM) standards although the present invention is not limited to application in such a system, and description thereof is illustrative only. The MTS 300 generally comprises one or more switching systems (SSs) 305-306 and base station subsystems (BSSs) 340-341 that provide mobile telecommunication services to one or more mobile devices 355. The mobile device 355 can take various forms such as a mobile laptop computer with a wireless modem capable of mobile terminations, a wireless personal digital assistant, a pager, a data-enabled cellular telephone, or other wireless communication device. The mobile device 355 communicates directly with one or more base transceiver stations (BTSs) 352A-352C and 353A-353C comprised within respective BSSs 340-341. Each BSS, for example BSS 340, will typically comprise one or more geographically diverse BTSs, for example BTSs 352A-352C. A group of BTSs, for example one of a BTS group 352-353, is managed by a base station controller (BSC) 345-346, also referred to as a radio network controller, comprised within a respective BSS 340-341. Each BSS 340-341 communicates with, and is controlled by, a respective mobile services switching center (MSC) 310-311 comprised within a switching system 305-306. Each individual BTS 352A-352C and 353A-353C defines a radio cell operating on a set of radio channels thereby providing service to one or more mobile devices 355. Accordingly, each BSC 345-346 will have a number of cells corresponding to the respective number of BTSs 352A-352C and 353A-353C controlled thereby.

Switching systems 305-306 respectively contain a number of functional units implemented in various hardware and software. Generally, each SS 305-306 respectively contains a MSC 310-311, a Visitor Location Register (VLR) 375-376, a Home Location Register (HLR) 370-371, an Authentication Center 381-382, and an Equipment Identity Register 385-86. Mobile device 355 operable within the MTS 300 has a register designated as a home register. In the present illustration, and in the examples provided hereinbelow, the HLR 371 represents the home register of the mobile device 355. HLR 371 is a database containing profiles of mobile devices having HLR 371 designated as the home register. The information contained within mobile device's 355 profile in HLR 371 comprises various subscriber information, for example authentication parameters such as an international mobile station equipment identity (IMEI), an electronic serial number (ESN) and an authentication capability parameter as well as subscription service parameters such as an access point name (APN) that defines the services comprised in the subscription. Additionally, mobile device's 355 HLR 371 profile contains data related to the current, or last known, location of mobile device 355 within MTS 300, for example a location area identifier. The location data contained within HLR 371 associated with mobile device 355 is dynamic in nature, that is it changes as mobile device 355 moves throughout the MTS 300. It should be understood that each MSC 310-311 may, and typically does, control more than one BSC 345-346. In FIG. 6, only one respective BSC 345-346 is shown controlled by MSC 310-311 to simplify discussion of the invention.

VLR 375-376 is a database that contains information about all mobile devices 355 currently being serviced by MSC 310-311 associated therewith. For example, VLR 376 will comprise information relating to each mobile device being serviced by MSC 311 and thus comprises information associated with all mobile devices currently serviced by BTSs 353A-353C that are controlled by associated BSC 346. When mobile device 355 enters a cell coverage area of a BTS controlled by another MSC, for example when mobile device 355 roams into the coverage area provided by BTS 352C, VLR 375 of SS 305 associated with BTS 352C will interrogate the mobile device's 355 HLR 371 for subscriber information relating to mobile device 355. This information is then transferred to VLR 375. At the same time, VLR 375 transmits location information to HLR 371 indicating the mobile device's 355 new position. The HLR profile associated with mobile device 355 is then updated to properly indicate the mobile device's 355 position. This location information is generally limited to a location area identifier. The information transmitted to VLR 375 associated with roaming mobile device 355 generally allows for call setups and processing for mobile device 355 without further interrogation of HLR 371, for example the mobile device's 355 authentication and subscription service parameters. Thus, when mobile device 355 attempts to perform or receive a call, for example a data call, SS 305 has the requisite information for performing the setup and switching functions to properly service mobile device 355. Additionally, VLR 375 will typically comprise more precise location information on mobile device 355 than HLR 371, for example VLR 375 may contain a BSC identifier indicating the particular BSC servicing mobile device 355.

Each SS 305-306 may also comprise an authentication center (AUC) 381-382 connected to HLR 370-371 of respective SS 305-306. AUC 381-382 provides authentication parameters to HLR 370-371 for authenticating mobile device 355-356. AUC 381-382 may also generate ciphering keys used for securing communications with mobile device 355. Additionally, SS 305-306 may also comprise an equipment identity register (EIR) 385-386 database that contains the international mobile station equipment identity used to uniquely identify one or more mobile devices. EIR 385-386 is used to validate mobile device 355 requesting service in MTS 300.

General packet radio services (GPRS) may be provided in MTS 300 for providing, for example, Internet services thereto. GPRS is a packet-switched, rather than circuit-switched, data service. For connecting to packet data network 360 to access general packet radio services such as wireless Internet services, a gateway GPRS support node (GGSN) 330 is typically comprised in MTS 300. One or more Serving GPRS Support Nodes (SGSN) 320-321 are comprised within the MTS 300 for providing mobile device 355 access to the GPRS services, for example administering packet data protocol (PDP) sessions as well as performing managerial functions such as mobile device authentication, identification and IMEI interrogations. Thus, GGSN 330 provides an interface for mobile telecommunications system 300 to packet data network 360 while SGSNs 320-321 enable mobile device 355 to communicate with GGSN 330, and thus packet data network 360, via mobile telecommunication system 300 infrastructures.

A GPRS-capable mobile device may access a packet data network by first performing an attach procedure. In general terms, the attach procedure is initiated by transmission of an Attach Request message to the SGSN servicing the mobile device. In the present illustrative example, mobile device 355 is currently located within a cell provided by BSS 341. SGSN 321 is connected to BSS 341 by a communication channel and thus is responsible for providing GPRS services to mobile device 355. SGSN 321 then identifies and authenticates mobile device 355 after which an Update Location message is transmitted to HLR 371. Authentication of the mobile device may comprise interrogation by SGSN 321 of various modules in SS 306 having the mobile device's home register therein, for example the SGSN may interrogate AUC 382 or EIR 386. In response, HLR 371 sends subscriber information to SGSN 321 as well as an acknowledgment of the location update.

To engage in packet communications, an attached mobile device 355 must then perform an activation procedure, for example a PDP activation. Generally, an Activation Request message is transmitted from mobile device 355 to SGSN 321. SGSN 321 then contacts GGSN 330 and requests a PDP activation. GGSN 330 maintains a record of the address of SGSN 321 servicing mobile device 355 so that packet data from data network 360 can be appropriately routed to mobile device 355. GGSN 330 will then update the SGSN address whenever the mobile device roams into a cell provided by a BTS serviced by another SGSN, for example when mobile device 355 roams into the cell provided by BTS 352C serviced by SGSN 320.

A mobile device of the present invention may maintain an instance of a network stack 90, or a variation thereof, for facilitating transmission and reception of communications with network 300. In a wireless implementation of the invention, network medium 101 may comprise a radio frequency link terminated by mobile device 355 and one of BTSs 352A-352C and/or 353A-353C. Mobile device 355 may incorporate the elements of network node 270, namely CPU 272, memory module 274 and may comprise a storage media 276 such that mobile device 355 is operable to execute IPS application 91. As aforementioned, IPS application 91 may comprise a client and/or server application. A client application is preferably maintained and run on mobile device 355. A server application may also run on mobile device 355 or may alternatively be run on network 300, for example by SS 306, and engage in wireless communication with mobile device 355 for facilitating operation of the client application of IPS application 91, for example to provide mobile device 355 with machine-readable signature files utilized by IPS application 91 to detect intrusion related events at mobile device 355. The functionality of management node 85 may be incorporated into a switching system by comprising a CPU for executing management application 279 within SSs 305 and 306. Thus, network attacks directed at a mobile device 355 may be detected and prevented.

What is claimed:

1. A mobile device operable in a mobile telecommunications network, comprising:
a memory module for storing data in machine readable format for retrieval and execution by a central processing unit; and
an operating system operable to execute an intrusion detection application stored in the memory module.

2. The mobile device according to claim 1, wherein the operating system further comprises a network stack comprising a protocol driver, a media access control driver, the intrusion detection application comprising an intermediate driver bound to the protocol driver and the media access control driver.

3. The mobile device according to claim 1, wherein the intrusion detection application further comprises an associative process engine and an input/output control layer, the input/output control layer operable to receive a signature file and pass the signature file to the associative process engine, the associative process engine operable to analyze a data packet with the signature file.

4. The mobile device according to claim 1, further comprising a storage media, the storage media operable to maintain a database of a plurality of signature files therein.

5. The mobile device according to claim 3, wherein the intrusion detection application identifies a correspondence between the signature file and a data packet, a determination that the data packet is intrusion-related made upon identification of the correspondence.

6. The mobile device according to claim 3, wherein the signature file comprises a directive that defines a process to be executed by the processor upon a determination that the data packet is intrusion-related.

7. The mobile device according to claim 5, wherein the directive comprises machine readable instructions that, when executed by the processor, cause the mobile device to log the data packet in a database.

8. The mobile device according to claim 1, wherein the intrusion detection application performs host-based intrusion detection by monitoring application logs of applications running on the mobile device.

9. The mobile device according to claim 1, wherein the intrusion detection application is operable to identify an event related to an intrusion of the mobile device, the mobile device operable to provide event-data related to the intrusion to a management node of the network.

10. The mobile device according to claim 9, wherein the management node is a mobile telecommunication network switching system.

11. A node of a network for managing an intrusion detection system, the node comprising:
a memory module for storing data in machine readable format for retrieval and execution by a central processing unit; and
an operating system comprising a network stack comprising a protocol driver and a media access control driver and operable to execute an intrusion protection system management application, the management application operable to receive text-file input defining a network-exploit rule and convert the text-file input into a signature file comprising machine-readable logic representative of an exploit-signature, the node operable to transmit the signature file to a mobile device over a radio frequency link.

12. The node according to claim 11, wherein the radio frequency link is terminated by the mobile device and a base transceiver station of a mobile communications network.

13. The node according to claim 11 further comprising at least one of a visitor location register and a home location register.
